(19) United States
(12) Patent Application Publication
(10) Pub. No.: US 2012/0285652 A1
(43) Pub. Date: Nov. 15, 2012

(54) Liner for a Die Body

(76) Inventors: Fathi Ahmad, Kaarst (DE); Gary B. Merrill, Orlando, FL (US); Uwe Paul, Ratingen (DE)

(21) Appl. No.: 13/103,338

(22) Filed: May 9, 2011

(51) Int. Cl. B22C 7/02; B28B 7/36

(52) U.S. Cl. 164/235; 249/112

(57) ABSTRACT

A liner for a die body is presented. The liner includes a flexible base material characterized in that reinforcements with lower stretchability compared to the base material are bonded along the extent of the liner. A tool which includes the liner is also provided. The reinforcements may include glass fibers or carbon fibers.

### FIELD OF INVENTION

The present invention relates to a liner for a die body and a tool with such a liner for making wax patterns.

### BACKGROUND OF INVENTION

Investment casting is commonly used in aerospace and power generation industries such as for manufacturing a blade or a vane or a ring segment for a gas turbine. These blades, vanes or ring segments can have a complex shape such as that of an airfoil which can be manufactured using the investment casting technique.

The production of an investment cast gas turbine blade or vane involves producing a ceramic casting mold having an outer ceramic shell with an inside surface corresponding to the airfoil shape, and one or more ceramic cores positioned within the outer ceramic shell corresponding to interior cooling passages to be formed within the airfoil. Molten alloy is poured into the ceramic casting vessel and is then allowed to cool and to solidify. The outer ceramic shell and ceramic core are then removed by mechanical or chemical means to reveal the cast blade or vane having the external airfoil shape and hollow interior cooling passages in the shape of the ceramic core.

A ceramic core for injection casting is manufactured by first precision machining the desired core shape into mating core tool or die halves formed of high strength hardened machine steel, then joining the tool or die halves to define an injection volume corresponding to the desired core shape, and injecting a ceramic material into the injection volume. The core material is a mixture of ceramic powder and binder material. Once the ceramic core material has hardened to a green state, the tool or die halves are separated to release the green state ceramic core. The fragile green state core is then thermally processed to remove the binder and to sinter the ceramic powder together to create a material that can withstand the temperature requirements necessary to survive the casting of the molten alloy. The next step in production the ceramic casting mold is to form a wax pattern of the component by positioning the ceramic core within the two joined halves of another precision machined hardened steel tool or die (referred to as a wax pattern mold or a wax pattern tool) which defines an injection volume that corresponds to the desired component shape, and thereafter injecting melted wax into the wax pattern tool or die around the ceramic core. Once the wax has hardened, the tool or die halves are separated and removed to reveal the ceramic core encased inside the wax pattern, with the wax pattern now corresponding to the cast component shape. Very often several such wax patterns are assembled to a cluster. The outer surface of the wax pattern is then coated with a ceramic mold material, such as by a repeated dipping process, to form the ceramic shell around the core/wax pattern and subsequent covering with ceramic particles to obtain a sufficient ceramic mold thickness. Thereafter, the wax is removed and the ceramic mold sintered and the completed ceramic casting vessel is now available to receive molten alloy in the investment casting process, as described above.

Currently, removal of wax pattern from the wax pattern tool is difficult and time consuming process. Furthermore, the removal of wax pattern may cause damage to the wax pattern tool and decrease the reusability of the wax pattern tool. Hence, flexible inserts or liners can be used to facilitate removal of wax pattern from the wax pattern tool especially for prototype production. However, during the filling of the cavity with wax, the flexible liner is exposed to strain and compression due to high wax injection pressure. This may result in local dimensional deviations in the wax pattern.

### SUMMARY OF INVENTION

It is therefore an object of the present invention to provide a liner for the wax tool body which is capable of withstanding strain and compression due to high wax injection pressure and also does not show deviations in the wax pattern.

The object is achieved by providing a liner for a die body according to the claims and a tool for forming a wax pattern according to the claims.

The present invention suggests a liner for a die body including a flexible base material, bonded by reinforcements of lower stretchability than the base material along the extent of the liner. By having reinforcements bonded to the base material, the stretchability of the base material is lowered. Additionally, the reinforcements also prevent deformation of the base material when subjected to high injection pressure during the wax injection process.

In one embodiment, the reinforcements are bonded on a first surface of the liner. The presence of reinforcements on the first surface of the liner reinforces the liner and minimizes or avoids dimensional deviations in the wax pattern.

In another embodiment, the reinforcements are bonded on a second or other subsequent surface of the liner, which enables easy removal of the liner from the die body.

In one embodiment, the reinforcements are formed from glass fibers. The glass fibers have high tensile strength thereby reinforcing the liner. Additionally, the glass fibers have a sufficient elasticity to survive certain bending.

In another embodiment, the reinforcements are formed from carbon fibers. Carbon fibers also have high tensile strength thereby reinforcing the liner and preventing deviations in the wax pattern. Additionally, the carbon fibers have a sufficient elasticity survive certain bending.

In one embodiment, the flexible base material comprises silicone which prevents sticking to the die body and can also be formed into a desired shape of the wax pattern.

Reinforcements are formed as thread, mat or fabric, based on shape and size of the wax pattern.

In one embodiment, the reinforcements are present locally along the extent of the liner. The reinforcements are applied locally to strengthen areas that are prone to distortion during the wax injection process.

In another embodiment, the reinforcements are present entirely along the extent of the liner. This enables all the regions in the liner to be protected from distortion during wax injection process.

### DETAILED DESCRIPTION OF INVENTION

The above-mentioned and other features of the invention will now be addressed with reference to the accompanying drawings of the present invention. The illustrated embodiments are intended to illustrate, but not limit the invention. The drawings contain the following figures, in which like numbers refer to like parts, throughout the description and drawings.

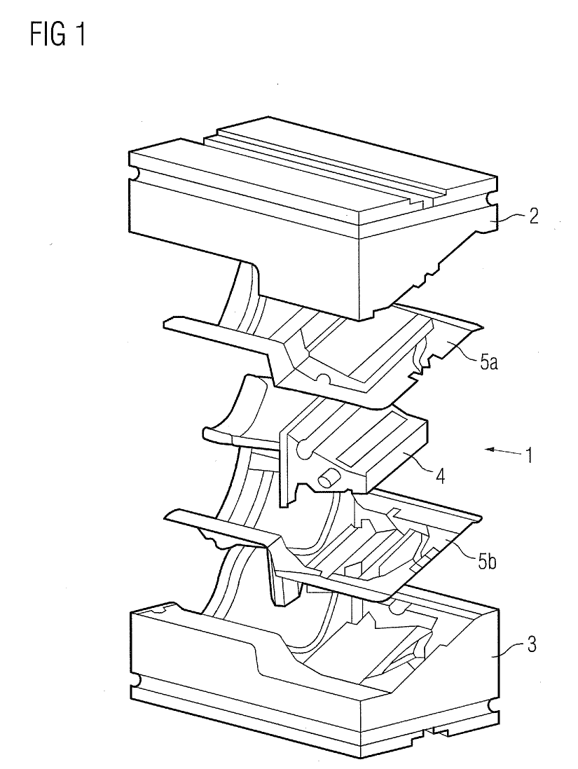

FIG. 1 is a schematic diagram of an exemplary tool for forming a wax pattern;

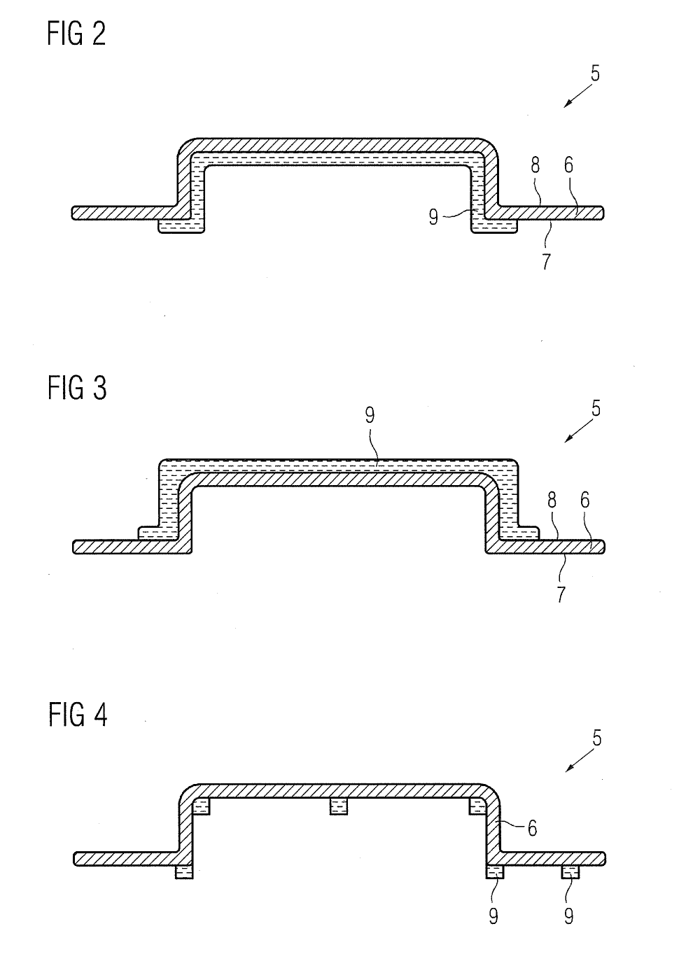

FIG. 2 is a cross-sectional view of an embodiment of a liner for the tool die body;

FIG. 3 is a cross-sectional view of another embodiment of liner for the tool die body; and

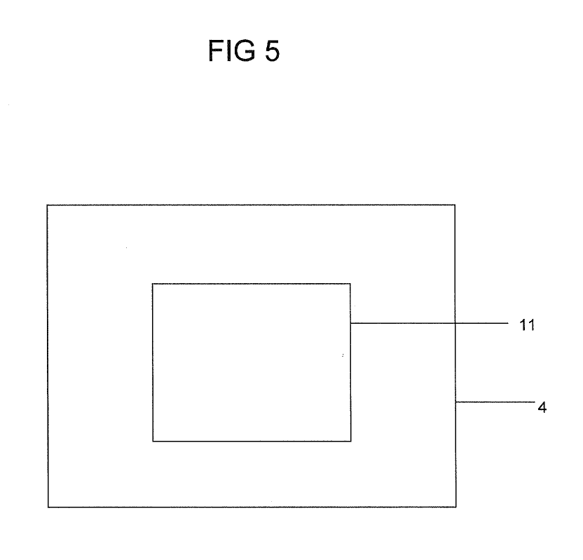

FIG. 4 is a cross-sectional view of yet another embodiment of the liner for the tool die body.

FIG. 1 is a schematic diagram of a tool 1 for forming wax pattern as a part of an investment casting process. The tool 1 includes a top mold or die 2 and a bottom mold or die 3 including a shape of component for a gas turbine or a steam turbine, such as but not limited to a blade or vane. It may be noted that the terms “mold” and “die” are used interchangeably throughout the present invention.

As will be appreciated, in the investment casting process, a ceramic core is produced to define the internal cooling passages of the blade or vane. The next step in the investment casting process is to use the core as a part of wax pattern tool for casting wax around the core to define an outer shape of the component of the turbine such as the blade or vane.

It may be noted that the exemplary tool 1 may also be used for forming a wax pattern for any component with complex internal cooling passages.

The die 2, 3 which is in the form of two halves, the top die 2 and the bottom die 3 may be formed of a soft metal such as machined aluminum or hard material such as steel. Alternatively, the die or mold may also be formed of wood. A liner which includes a top liner 5a and a bottom liner 5b may be formed of flexible material capable of withstanding high temperature, such as, but not limited to silicones are placed over the top die 2 and the bottom die 3 respectively. The top liner 5a and the bottom liner 5b are designed such that they could fit easily into the dies 2, 3 respectively. More particularly, the liners 5a, 5b are formed into the shape of the interior of the top die 2 and the bottom die 3. It may be noted that the liners 5a, 5b are placed on the inner surface of the die 2, 3 as depicted in FIG. 1.

A wax pattern 4 is produced by pouring the molten wax in the die 2, 3 including the liners 5a, 5b and allows the wax to cool until a desired thickness has set on the surface of the die 2, 3. Alternatively, the wax pattern 4 is produced by injecting the molten wax using a plurality of shots at a pressure which may be from around 5 bars to around 10 bars, for example. This process is generally known as the wax injection process. It may be noted that for creating wax pattern 4 parameters such as wax temperature, pressure and mold temperature need to be optimized. The molten wax when cooled solidifies to produce the wax pattern 4.

FIG. 2 is a cross-sectional view of the exemplary liner 5, such as the top liner 5a and bottom liner 5b illustrated in FIG. 1, in accordance with aspects of the present technique. As illustrated, the liner 5 includes a flexible base material 6. The flexible base material 6 may be formed from silicone for example. The liner 5 has a first surface 7 and a second surface 8. However, alternatively, the liner 5 could have more surfaces. It may be noted that the second surface 8 of the liner 5 is proximal to the mold or die 2, 3 (see FIG. 1). More particularly, the liner 5 is placed on the inner surface of the mold such that the second surface of the liner 5 is indexed to the mold or die 2, 3 (see FIG. 1).

In accordance with aspects of the present technique, reinforcement 9 is attached to the flexible base material 6. In one embodiment, the reinforcement 9 may be bonded to the flexible base material 6 to form the exemplary liner 5. It may be noted that the reinforcement 9 may be formed from a material which has lower stretchability than the flexible base material 6. In the presently contemplated configuration, the reinforcement 9 is formed from a material such as glass fiber. Alternatively, the reinforcement 9 may be formed from material such as, but not limited to carbon fiber, Kevlar, Teflon and so forth.

The exemplary liner 5 may be formed by mixing the reinforcement 9, which are glass fibers for example into liquid silicone which forms the flexible base material 6. This mixture is cooled and the liner 5 with reinforcement 9 bonded to the flexible base material 6 is obtained. These reinforcements 9 may be in the shape of threads, mat, fabric and so forth.

With continuing reference to FIG. 2, the reinforcement 9 may be bonded to the flexible base material 6 such that the reinforcement 9 is present on the first surface 7 of the liner 5. More particularly, the reinforcement 9 is present at an interface between the liner 5 and the dies 2, 3.

FIG. 3 is a cross-sectional view of another embodiment of the exemplary liner 5 in accordance with aspects of the present technique. The reinforcement 9 is bonded to the flexible base material 6 such that it is present at the second surface 8 of the liner 5. In the present embodiment, the reinforcement 9 may be coated with or infiltrated with a material which produces a smooth surface of the liner 5. The material may include resin, for example.

FIG. 4 is a cross-sectional view of the liner 5, depicting the presence of reinforcement 9 at different regions along the extent of the liner 5. More particularly, the reinforcements 9 are present at areas prone to distortion during the wax injection process. These areas may include regions of the die that are unsupported due to thicker local mold profile or the areas of the die that contain internal struts or locating features.

The exemplary liner as described hereinabove has several advantages such as the liner causes less or no dimensional variations within the wax pattern caused by strain or compression during the wax injection process. In addition, the wax pattern tool with the liner may be used for prototype and even first production sets. The exemplary liner also has very smooth surfaces which reduce friction during wax injection thereby resulting in less strain or compression in the liner. Furthermore, a significant reduction in cost is achieved through the use of the liners and described hereinabove.

Although the invention has been described with reference to specific embodiments, this description is not meant to be construed in a limiting sense. Various modifications of the disclosed embodiments, as well as alternate embodiments of the invention, will become apparent to persons skilled in the art upon reference to the description of the invention. It is therefore contemplated that such modifications can be made without departing from the embodiments of the present invention as defined.

1. A liner for a die body, comprising:
a flexible base material,
wherein a plurality of reinforcements with lower stretchability compared to the base material are bonded along an outer extent of the liner,
wherein the plurality of reinforcements are in the form of a thread, a mat, or a fabric, and
wherein the plurality of reinforcements prevent deformation of the flexile base material when subjected to high injection pressure during an investment casting process.

2. The liner according to claim 1, wherein the plurality of reinforcements are bonded on a first outer surface of the liner.

3. The liner according to claim 1, wherein the plurality of reinforcements are bonded on a second outer surface of the liner.

4. The liner according to claim 1, wherein the plurality of reinforcements comprise glass fibers.

5. The liner according to claim 1, wherein the plurality of reinforcements comprise carbon fibers.

6. The liner according to claim 1, wherein the flexible base material comprises silicone.

7. (canceled)

8. The liner according to claim 1, wherein the plurality of reinforcements are present locally along the extent of the liner.

9. The liner according to claim 1, wherein the plurality of reinforcements are present entirely along the extent of the liner.

10. A tool for forming a wax pattern as part of an investment casting process, the tool comprising:
a die;
a core disposed within and supported in position relative to the die, and
a liner disposed at an inner surface of the die, the liner comprising a flexible base material,
wherein a plurality of reinforcements with lower stretchability compared to the flexible base material are bonded along an extent of the liner, and
wherein the plurality of reinforcements are in the form of a thread, a mat, or a fabric, and
wherein the plurality of reinforcements prevent deformation of the flexile base material when subjected to high injection pressure during an investment casting process.

11. The tool according to claim 10, wherein the plurality of reinforcements are present at a first surface of the liner.

12. The tool according to claim 10, wherein the plurality of reinforcements are present at a second surface of the liner.

13. The tool according to claim 10, wherein the plurality of reinforcements in the liner comprises glass fibers.

14. The tool according to claims 10, wherein the flexible base material comprises silicone.
